(19) United States
(12) Patent Application Publication
(10) Pub. No.: US 2003/0043006 A1
(43) Pub. Date: Mar. 6, 2003

(54) Inductor with variable air-gap separation

(76) Inventors: Xiaodong Sun, Taipei Hsien (TW); Yanfang Liu, Taipei Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/879,942

(22) Filed: Jun. 14, 2001

(51) Int. Cl. H01F 17/06

(52) U.S. Cl. 336/178

(57) ABSTRACT

An inductor with multiple air-gap separations comprises a magnetic core and an enameled wire around the magnetic core. The magnetic core has an air gap with at least a large-gap portion and a small-gap portion. The small-gap portion provides enough inductance in case of low load input to prevent harmonic distortion. The large-gap portion provides enough inductance in case of heavy load output and low input voltage to prevent saturation and temperature rise, thus enhancing power efficiency.

### FIELD OF THE INVENTION

The present invention relates to an inductor with multiple air-gap separations, especially to an inductor having air-gap with multiple separations to provide better electrical property.

### BACKGROUND OF THE INVENTION

The prior art inductor for large-current application generally has large-volume silicone-steel plates, and an air gap for increasing reluctance thereof, thus preventing saturation of the inductor. As shown in FIG. 1A and FIG. 1B, an inductor 1a is composed of an I-shaped silicone-steel plate 11a and an E-shaped silicone-steel plate 12a, and an air gap 13a with uniform separation between the I-shaped silicone-steel plate 11a and the E-shaped silicone-steel plate 12a.

However, the air gap 13a with uniform separation has some disadvantages. If the air gap 13a is small, the inductor 1a is saturated and the inductance thereof is increased and temperature is increased in heavy load case (larger current). If the air gap 13a is large, the inductance is not enough to prevent harmonic distortion in low load case (small current). The temperature cannot be decreased to enhance efficiency in low output voltage and heavy load condition.

As can be seen from above description, the inductor having air gap with uniform separation has serious problem.

### SUMMARY OF THE INVENTION

It is the object of the present invention to provide an inductor with multiple air-gap separations to overcome above problem.

To achieve above object, the present invention provides an inductor with multiple air-gap separations comprises a magnetic core and an enameled wire around the magnetic core. The magnetic core has an air gap with at least a large-gap portion and a small-gap portion. The small-gap portion provides enough inductance in case of low load input to prevent harmonic distortion. The large-gap portion provides enough inductance in case of heavy load output and low input voltage to prevent saturation and temperature rise. The air gap has a surface of stair shape, bevel shape or a curved surface to optimize the electrical property of the inductor.

The various objects and advantages of the present invention will be more readily understood from the following detailed description when read in conjunction with the appended drawing, in which:

### BRIEF DESCRIPTION OF DRAWING

FIG. 1A shows the perspective view of the prior art inductor;

FIG. 1B shows the front view of the prior art inductor;

FIG. 2A shows the perspective view of the I-shaped silicone-steel plate padded with paper in the present invention;

FIG. 2B shows the front view of the I-shaped silicone-steel plate padded with paper in the present invention;

FIG. 3A is a left side view of E-shaped silicone-steel plate subjected to punching in the present invention;

FIG. 3B is a right side view of E-shaped silicone-steel plate subjected to punching in the present invention;

FIG. 4 shows the relationship between inductance and current of the inventive inductor;

FIG. 5A is a front view of air gap with bevel plane in the present invention; and

FIG. 5B is a front view of air gap with a curved surface in the present invention.

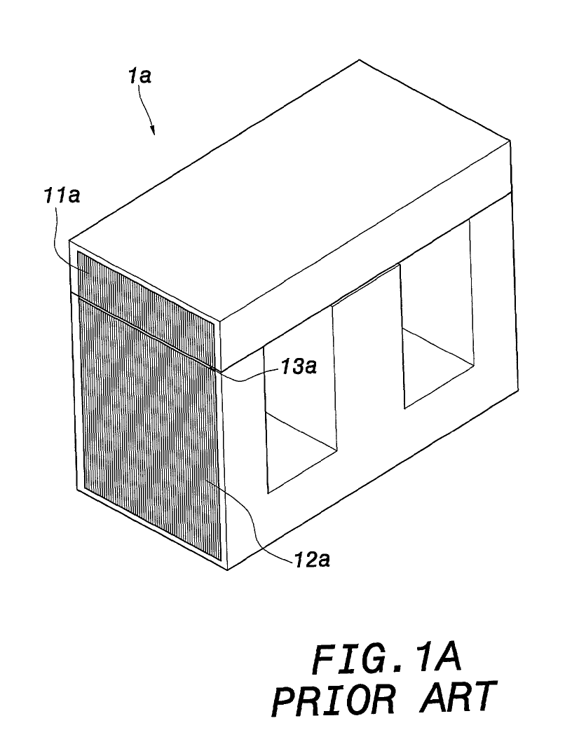

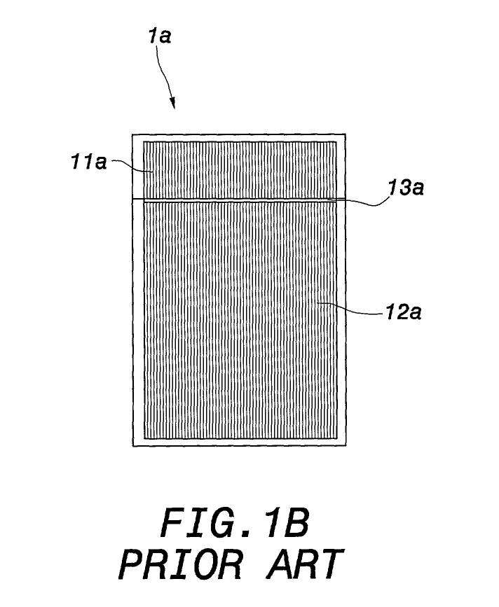

### DESCRIPTION OF THE INVENTION

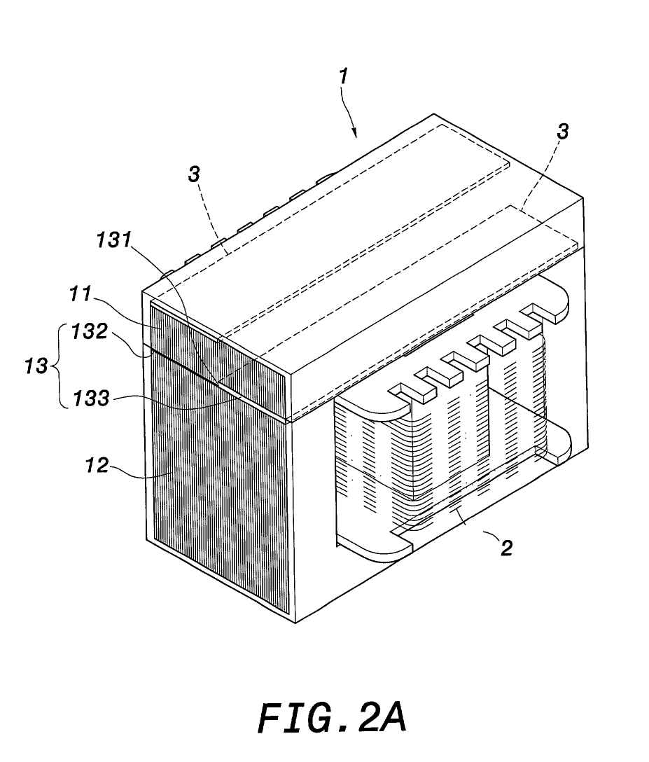

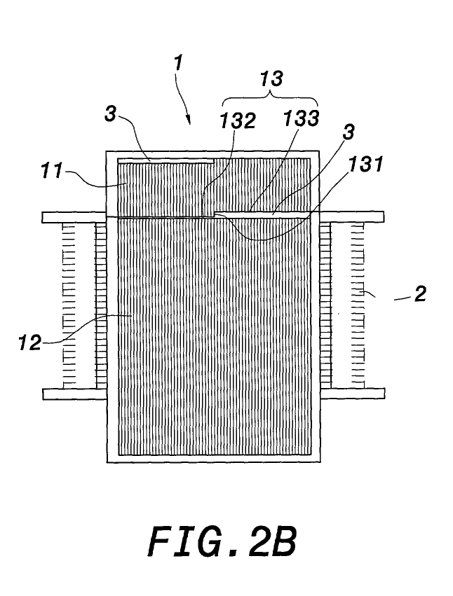

With reference now to FIGS. 2A and 2B, the present invention provides an inductor with multiple air-gaps combination. The inductor according to the present invention is composed of a magnetic core 1 and an enameled wire 2 around the magnetic core 1. The magnetic core 1 is composed of a plurality of silicone-steel plates including an I-shaped silicone-steel plate 11 and an E-shaped silicone-steel plate 12. The I-shaped silicone-steel plate 11 is padded with papers 3 on topside and bottom side thereof to provide an air gap with various separations such that the surface 131 of the air gap 13 is of stair shape and composed of a small-gap portion 132 and a large-gap portion 133 to provide an air gap 13 with various separations.

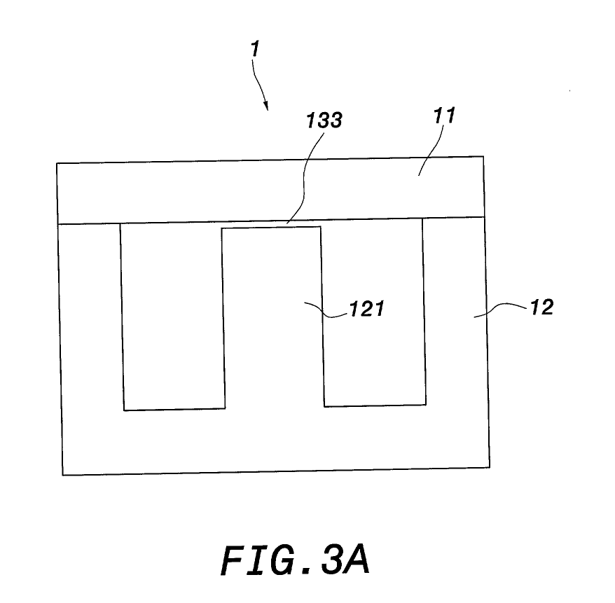

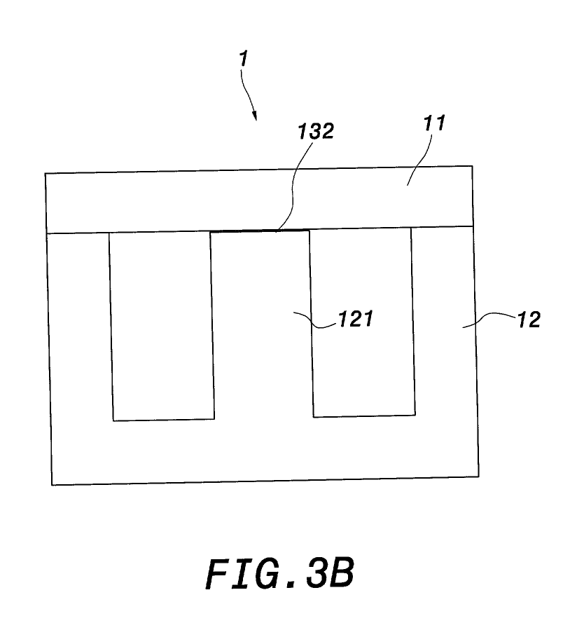

The air gap 13 with various separations can be formed by other ways than padding with paper. As shown in FIGS. 3A and 3B, the center bar 121 of the E-shaped silicone-steel plate 12 is punched and pressed to form the small-gap portion 132 and the large-gap portion 133, before the enameled wire 2 is arranged.

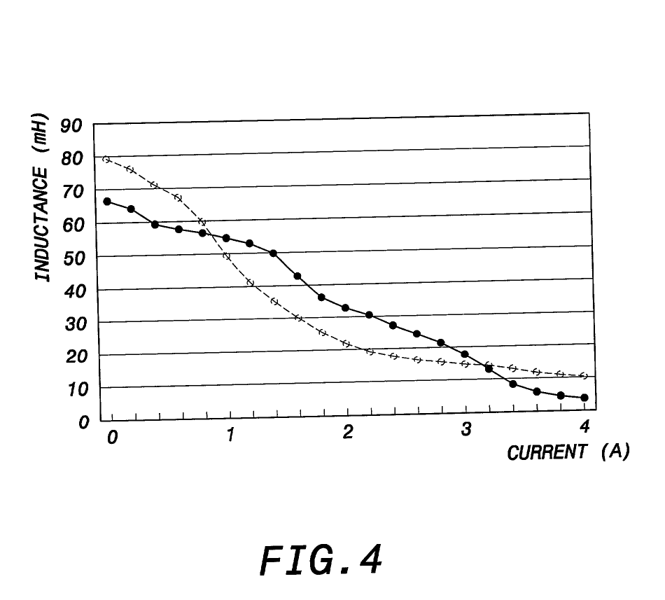

Provided that the input power is 150 W, in the present invention, the small-gap portion 132 has separation of 5 mils (1 mil=0.001 inch), and the large-gap portion 133 has separation of 45 mils. Moreover, the small-gap portion 132 and the large-gap portion 133 each occupy 50% area of the air gap 13, i.e., the area ratio is 1:1. The relationship between inductance and current of the inventive inductor is represented by the solid line in FIG. 4. As compared with an inductor having air gap with uniform separation 12 mils (represented by the dash line in FIG. 4), the inventive inductor with air gap of various separation has larger inductance in conditions of large current (3-4 A) and small current (below 0.9 A).

Therefore, the small-gap portion 132 of the inventive inductor provides enough inductance in case of low load input to prevent harmonic distortion. The large-gap portion 133 of the inventive inductor provides enough inductance in case of heavy load output and low input voltage to prevent saturation and temperature rise, thus enhancing power efficiency. The electrical property of the inventive inductor can be optimized by controlling the various separations.

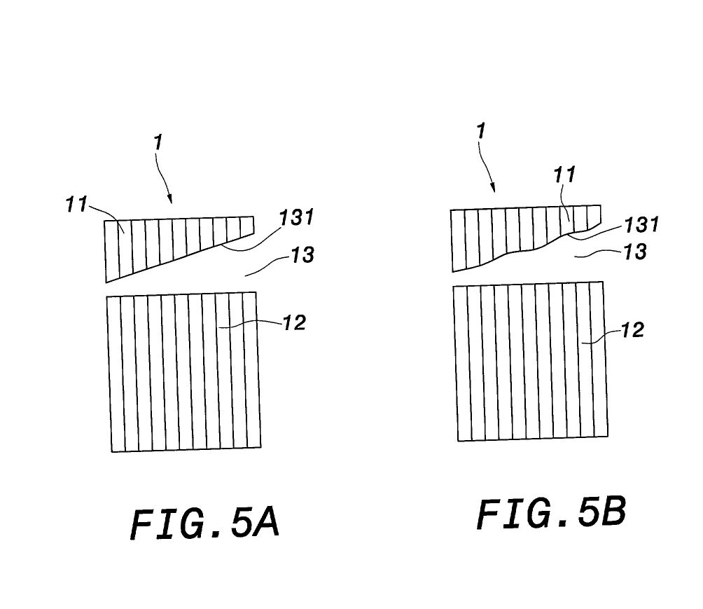

Moreover, as shown in FIGS. 5A and 5B, the surface 131 of the air gap 13 can also be bevel plane or a curved surface.

To sum up, the inductor with multiple air-gap separations according to the present invention has following advantages:

(1) The harmonic distortion can be prevented in low load condition.

(2) The temperature rise can be prevented in condition of heavy load output and low input voltage.

(3) The power efficiency is enhanced.

(4) The volume of inductor is reduced.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

I claim

1. An inductor with multiple air-gap separations, comprising a magnetic core and an enameled wire around the magnetic core, the magnetic core having an air gap with at least two different separations, the air gap having a surface of stair shape, bevel shape or a curved surface to optimize the electrical property of the inductor.

2. The inductor with multiple air-gap separations as in claim 1, wherein the magnetic core is composed of a plurality of silicone-steel plates.
